(19) United States
(12) Patent Application Publication
(10) Pub. No.: US 2013/0000666 A1
(43) Pub. Date: Jan. 3, 2013

(54) Multi-Function Teeth Cleaning Device

(76) Inventor: Kun HU, West Covina, CA (US)

(21) Appl. No.: 13/403,673

(22) Filed: Feb. 23, 2012

(30) Foreign Application Priority Data
Jun. 29, 2011 (CN) 201110180811.0
Jun. 29, 2011 (CN) 201120226888.2

(51) Int. Cl. A61C 17/22; A61C 15/04; A61C 15/00; A46B 15/00; A46B 13/02

(52) U.S. Cl. 132/309; 132/322

(57) ABSTRACT

Present invention teaches to modular and removable/attachable teeth cleaning device, wherein an electro-magnetic driver pump or a motor piston pump on the handle will actuate the mechanism on the nozzle, shooting water jet blocks out the tapered tip, and also a length of a floss string to oscillate in and out of the tapered nozzle tip. Other alternative implementations of removable module can be interchangeably selected for attaching to the handle of said invention, for added convenience and functionality.

### CLAIM FOR FOREIGN PRIORITY

The present invention claims the foreign priority of a Chinese application, number 201120226888.2, having priority date of Jun. 29, 2011, and another Chinese application, number 201110180811.0, also having priority date of Jun. 29, 2011.

### FIELD AND BACKGROUND OF THE INVENTION

It is well known that the main cause of tooth decay and gingivitis can be attributed to lasting formation of dental plaque that is the result of less than ideal teeth cleaning, brushing and general maintenance of oral hygiene.

Despite such knowledge and the different types of teeth cleaning devices available, such as the traditional tooth brush, electrical tooth brush and flossing device, the functions and usage are limited by their physical structure and there exists a need for a modular, multi-function teeth cleaning device that would allow the multi-faceted cleaning function to be in a interchangeable and all-in-one manner.

The present invention relates generally to the such a multi-function device that contains a removable and versatile module driving by an electro-magnetic pump or a motor piston pump on a handle, causing water jet blocks and/or floss to work in conjunction with each other, or separately, and provides an ideal cleaning service to users.

The preferred embodiment of the water jetting and reciprocating flossing stream serves to effectively remove food debris that may be left in the gaps between teeth and in the difficult-to-reach inside corners inside the mouth, and will greatly help to reduce the accumulation of germs and formation of dental plaque.

### OBJECTS AND SUMMARY OF THE INVENTION

Present invention disclosed and claimed a teeth cleaning device where the use of water jet blocks and a string of floss can be combined for usage together, providing a unique way of reducing the formulation of dental plaque, in a single operation, when such modular unit is attached to the handle.

The objective of present invention is to create a modular and interchangeable device that gives the all-in-one convenience to users for purpose of better oral hygiene maintenance.

It is a further objective of present invention to allow the user the ability to control the selected function and the strength or magnitude of the function being selected to perform the cleaning function.

It is another objective of present invention to put a display module on the handle, so that the user is provided with visual feedback of the selected function and the flexibility of controlling the desired strength of magnitude of the function being selected, based upon the visual display.

It is yet another objective of present invention to employ a non-contact induction power charging and receiving module, so that the device being used for dental cleaning in a normally damp and wet environment poses no safety hazard to humans.

It is a still further objective of present invention to create the oscillating, back-and-forth movement of a flossing string, by the movement of a piston and with the assistance of a spring mechanism, so that the flossing function works harmoniously with the water jetting function.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows an overall view of the teeth-cleaning device as described herein, with the dotted line portion signifying the removable module.

FIG. 2 shows the enlarged portion of the handle, connecting to the removable module.

FIG. 3 shows one implementation of the removable module and its constituent parts.

FIG. 4 shows the system architecture of the controlling PCB Board.

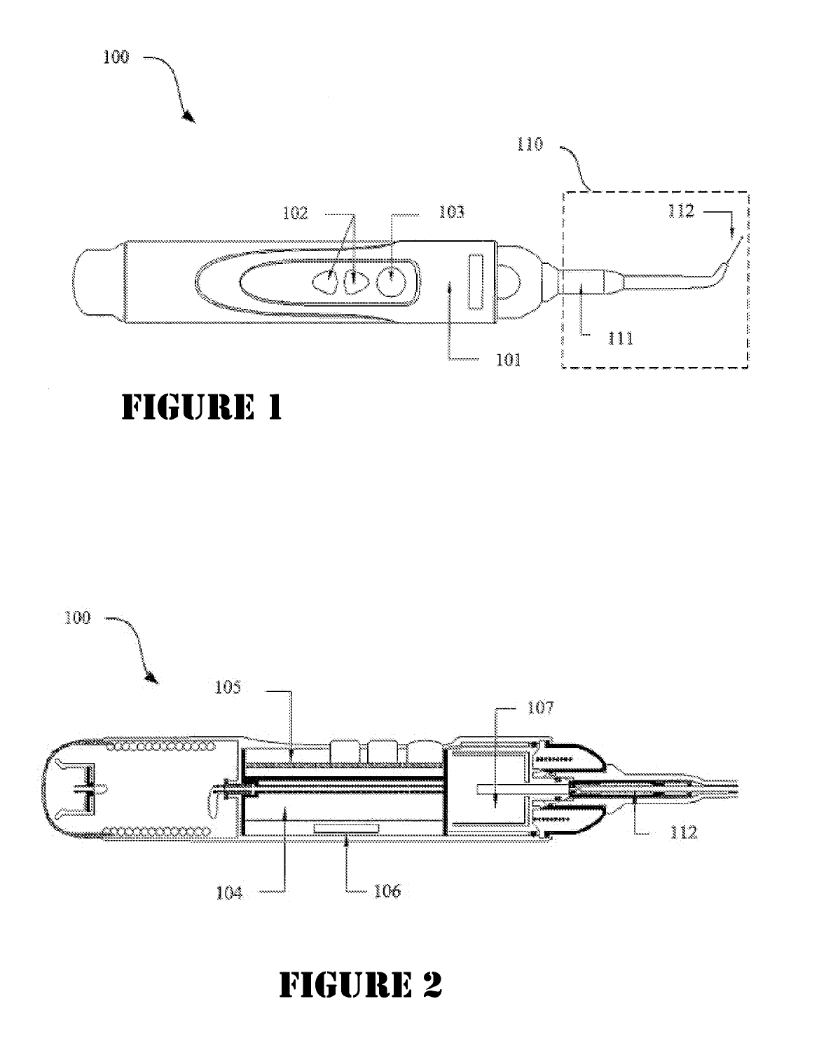

### DETAILED DESCRIPTION OF THE PREFERRED EMBODIMENT

As shown herein, the preferred embodiment of the present invention of a multi-function teeth cleaning device 100, comprising a handle 101 and a removable module 110 that provides the actual cleaning function for teeth and is driven by said handle 101 when attached.

The handle 101 is generally in a cylindrical shape, wherein one of the two ends will be the attaching end to a removable module 110.

The removable module 110 can be a functional module that performs water spraying/jetting, pulsating brushing, or other compatible cleaning units that may be used to help the maintenance of oral hygiene.

The removable module 110, as specifically described herein, includes water jetting and flossing functions, as will be disclosed in more details later.

A power switch 103 is located on the hand-holding side of the handle 101, as shown in FIG. 1. Functional keys 102 are placed next to said power switch 103, to allow user control of certain selected function.

The main system architecture of handle 101 is made up of a PCB Board 105, a battery unit 104, a power induction receiving module 106, and an driver pump 107, which can be an electro-magnetic pump or a motor piston pump.

To charge power to the battery unit 104, a commercially available non-contact induction charger unit is used, for connecting to the induction receiving module 106. The charger circuitry of Artco's AP1201 is used, as an example herein.

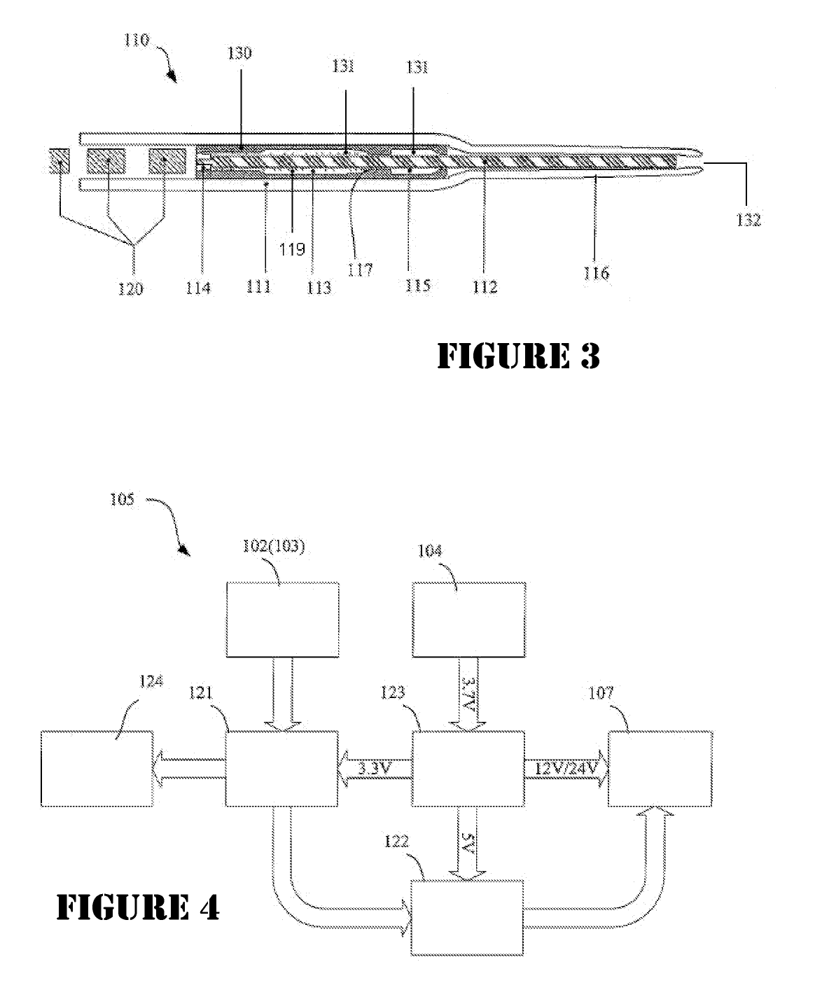

The system architecture of the PCB Board 105 is shown in FIG. 4, where an embedded processor module 121 receives user input (power switch 103 and function key 102 strokes), and activates desired action, with voltage derived from the voltage converter module 123, to drive the pump 107, which then in turns causes the needed action to propagate to the removable module 110.

As an example, the industrial grade ATmega48 processor of ATMEL can serve as the embedded processor module 121 of present application.

Voltage converter module 123 works to convert 3.7v power supplied from the battery unit 104 to the needed voltages of 3.3v, 5v, 12v or 24v used internally by different parts or components. Said electro-magnetic driver pump 107 (or motor piston pump 107) runs on either 12v or 24v power and also relies upon the voltage converter module 123 to get the voltage conversion from the 3.7v of the battery unit 104.

A driver module 122, getting its 5v power from the voltage converter module 123, will work with the embedded processor module 121 and in turn drives pump 107 to produce the needed water jetting blocks 120, or a steady soft-flowing stream of water, as desired.

Said function keys 102 can be used to control the water pressure or the jetting frequency, when the cleaning removable module 110 is attached. A display module 124 is located on an external surface of said handle 101, and will be controlled by said embedded processor module 121, to show the status, desired strength level of the selected function and other information reflecting the operating status of the device.

The removable module 110 may be attached to and detached from one end of said handle 101, and is generally in the form of a round tube nozzle, denoted as nozzle 111, with a tapered nozzle tip 116 made towards the distal end of nozzle 111. See FIG. 3.

A layer of inner padding 130 can be inserted into the inside of nozzle 111 and will closely stick along the inner wall circumference of the nozzle 111 portion of said module 110, to create segmented chamber spaces, referred to as first chamber 119 and second chamber 115. There is no inner padding 130 inside the tapered nozzle tip 116 portion.

FIG. 3 serves to illustrate these structural implementations stated herein.

Said inner padding 130 forms an inner bore 131, whose defined space would extend the same axial direction through inner space 132 of said tapered nozzle tip 116, allowing a stream of water to come out of said nozzle tip 116, or a floss string 112 to come out (and retract back into) said nozzle tip 116.

Said inner bore 131 further forms a padding neck point 117, which serves to define and separate two chambers 119 and 115, and also to serve as a stoppage point to hold piston 114 in place.

At one end of the nozzle 111 near the attachment point to the handle 101, a piston 114 is located at the opening of said inner padding 130. A floss string 112 is attached to said piston 114 and extends throughout the inner bore 131 and inner space 132 of said tapered nozzle tip 116.

A spring 113 is placed inside the first chamber 119, along the interior wall of padding 130, providing the resilient force to restore said piston/floss string (114/112) back to position during the pulsating operation of the water jetting out, as well as the force to drive the back-and-forth oscillation movements of said floss string 112.

The water jet blocks 120 on FIG. 3 serve to show the stream of water jets being pushed and shot out by the driver pump 107, when said removable module 110 is connected to said handle 101, during normal usage.

Said driver pump 107 will be located inside said handle 101, near the attaching end for attaching a removable module.

Also, during normal usage, a short stub length of said floss string 112 will be actuated to oscillate in and out of the tapered nozzle tip 116, in synchronized motion with the piston 114 movements and the water jet blocks 120 that are being shot through the inner bore 131. The “out” motion of the floss string 112 will be produced when the water pressure pushes the piston 114 outward; the “in” motion of the floss string 112 will be produced when the spring 113 resiliently pulls back in.

Other implementations of removable module 110 may be devised to work with the handle 101 described herein, as long as the physical dimensions are made to be connectable and attachable to said handle 101.

Alternative implementations may include another removable module 101 where the flossing string is eliminated, thus consisting of only water jetting blocks 120 during normal usage.

Another alternative implementation would be the cessation of water jetting blocks 120, but merely the reciprocating movements of the piston 114, driving the flossing string 112, along with a soft-flowing water stream coming out from the tapered nozzle tip 116.

In selected actual implementations, said tapered nozzle tip 116 may be made to bend slightly. However, such slight bending is still within the claimed scope of present application and does not affect any of the disclosure herein.

What is claimed is:

1. A multi-function teeth cleaning device, comprising:
a. A cylindrically shaped handle containing a battery unit, a non-contact induction power receiver module, a driver pump, a user-operable power switch and function keys; and,
b. a removable module that may be attached to and detached from one end of said handle, said removable module is in the shape of a tube-like nozzle further consisting of a tapered nozzle tip at the distal end and an inner padding defining an inner bore having a first chamber to hold a spring mechanism, a padding neck point, and a second chamber, said inner bore extends axially throughout the length of said nozzle, wherein a piston is fitted to a first opening of said inner padding, with a connecting floss string going through the inner bore of said inner padding and the chambers and through the inner space of said tapered nozzle tip.

2. The teeth cleaning device of claim 1, whereby said floss string shall have back-and-forth reciprocal actions, extending a small length out of the tapered nozzle tip, in synchronized motion with the piston movements and water jet blocks that will be shot through the inner bore of said inner padding.

3. The teeth cleaning device of claim 2, wherein a driver pump is located near the attaching end of the handle for activating the water jet blocks that will be shot through the inner bore of said inner padding and the tapered nozzle tip.

4. The teeth cleaning device of claim 3, wherein said handle further containing an embedded processor module, which controls a voltage converter module to convert battery unit's nominal voltage to the needed 12v or 24 v power consumption of said driver pump.

5. The teeth cleaning device of claim 4, wherein a display module is located on said handle and is controlled by said embedded processor module, to show the working status of said device.

6. The teeth cleaning device of claim 5, wherein said removable module may optionally be made to have no floss string attached to said piston.

7. The teeth cleaning device of claim 5, wherein said removable module may optionally be made to work with soft-flowing water stream, but not water jetting blocks.

8. The teeth cleaning device of claim 5, wherein said removable module may be supplied by other third-party business performing traditional brushing function with a pulsating brush head.
